(19) United States
(12) Patent Application Publication
(10) Pub. No.: US 2025/0280293 A1
(43) Pub. Date: Sep. 4, 2025

(54) INFORMATION PROCESSING METHOD AND APPARATUS, AND TERMINAL

(71) Applicant: VIVO MOBILE COMMUNICATION CO., LTD., Dongguan (CN)

(72) Inventors: Ranran HE, Dongguan (CN); Wei BAO, Dongguan (CN); Xiaodong YANG, Dongguan (CN); Qian ZHENG, Dongguan (CN)

(21) Appl. No.: 19/209,839

(22) Filed: May 16, 2025

Related U.S. Application Data
(63) Continuation of application No. PCT/CN2023/001270, filed on Oct. 27, 2023.

(30) Foreign Application Priority Data
Nov. 16, 2022 (CN) 202211461102.4

(51) Int. Cl. H04W 12/08; H04W 48/16; H04W 48/20

(52) U.S. Cl. CPC H04W 12/08; H04W 48/16; H04W 48/20

(57) ABSTRACT

This application discloses an information processing method and apparatus, and a terminal, and pertains to the field of communication technologies. The information processing method in embodiments of this application includes: A terminal receives target information of a target cell in a cell selection or reselection process, where the target information includes at least one of a MIB and a SIB 1; and in a case that security of the target information is not verified, the terminal applies a part of parameters in the target information.

### CROSS-REFERENCE TO RELATED APPLICATIONS

This application is a continuation of International Patent Application No. PCT/CN2023/127043, filed on Oct. 27, 2023, which claims priority to Chinese Patent Application No. 202211461102.4, filed on Nov. 16, 2022 in China, both of which are incorporated herein by reference in their entireties.

### TECHNICAL FIELD

This application pertains to the field of communication technologies, and specifically relates to an information processing method and apparatus, and a terminal.

### BACKGROUND

System information (SI) includes a master information block (MIB) and a series of system information blocks (SIB). In a mobile communication system in a related field, a network-side device (for example, a base station) sends system information in a broadcast manner, content of the system information is sent in plaintext without security verification, and a terminal (also referred to as user equipment) receives the system information and directly applies all parameters of the system information. In this way, in a case that the system information is system information sent by an illegal network-side device, it is easy to cause the terminal to perform an operation according to an indication of the illegal network-side device, or even access the illegal network-side device. Consequently, it is prone to a security risk.

### SUMMARY

Embodiments of this application provide an information processing method and apparatus, and a terminal.

According to a first aspect, an information processing method is provided. The method includes:
A terminal receives target information of a target cell in a cell selection or reselection process, where the target information includes at least one of a master information block MIB and a system information block 1 SIB 1; and
in a case that security of the target information is not verified, the terminal applies a part of parameters in the target information.

According to a second aspect, an information processing apparatus is provided, and is used in a terminal. The apparatus includes:
a first receiving module, configured to receive target information of a target cell in a cell selection or reselection process, where the target information includes at least one of a MIB and a SIB 1; and
a first processing module, configured to: in a case that security of the target information is not verified, apply a part of parameters in the target information.

According to a third aspect, an information processing method is provided. The method includes:

In a case that a second condition is met, a terminal does not apply a second system information block SIB of a target cell, where
the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and/or
in a case that a third condition is met, the terminal applies a second SIB of a target cell, where the third condition includes at least one of the following: a MIB, a SIB 1, and the second SIB all succeed in security verification, and the second SIB succeeds in security verification.

According to a fourth aspect, an information processing apparatus is provided, and is used in a terminal. The apparatus includes:
a fifth processing module, configured to: in a case that a second condition is met, not apply a second system information block SIB of a target cell; and/or in a case that a third condition is met, apply a second SIB of a target cell, where
the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and
the third condition includes at least one of the following: the MIB, the SIB 1, and the second SIB all succeed in security verification, and the second SIB succeeds in security verification.

According to a fifth aspect, a terminal is provided. The terminal includes a processor and a memory, and the memory stores a program or an instruction that can be run on the processor; and when the program or the instruction is executed by the processor, the steps of the method according to the first aspect are implemented.

According to a sixth aspect, a terminal is provided. The terminal includes a processor and a communication interface. The communication interface is configured to receive target information of a target cell in a cell selection or reselection process, where the target information includes at least one of a MIB or a SIB 1; and the processor is configured to: in a case that security of the target information is not verified, apply a part of parameters in the target information.

According to a seventh aspect, a terminal is provided. The terminal includes a processor and a memory, and the memory stores a program or an instruction that can be run on the processor; and when the program or the instruction is executed by the processor, the steps of the method according to the third aspect are implemented.

According to an eighth aspect, a terminal is provided. The terminal includes a processor and a communication interface. The processor is configured to: in a case that a second condition is met, not apply a second system information block SIB of a target cell; and/or in a case that a third condition is met, apply a second SIB of a target cell, where the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and the third condition includes at least one of the following: the MIB, the SIB 1, and the second SIB all succeed in security verification, and the second SIB succeeds in security verification.

According to a ninth aspect, a readable storage medium is provided. The readable storage medium stores a program or an instruction; and when the program or the instruction is executed by a processor, the steps of the method according to the first aspect are implemented, or the steps of the method according to the third aspect are implemented.

According to a tenth aspect, a chip is provided. The chip includes a processor and a communication interface, the communication interface is coupled to the processor, and the processor is configured to run a program or an instruction, to implement the steps of the method according to the first aspect, or implement the steps of the method according to the third aspect.

According to an eleventh aspect, a computer program/program product is provided. The computer program/program product is stored in a storage medium, and the computer program/program product is executed by at least one processor, to implement the steps of the method according to the first aspect, or implement the steps of the method according to the third aspect.

In embodiments of this application, the terminal receives the target information of the target cell in the cell selection or reselection process, where the target information includes at least one of the MIB and the SIB 1. In a case that security of the target information is not verified, the terminal applies only the part of parameters in the target information, that is, only the part of parameters in the target information are applied before security of the target information is verified.

### BRIEF DESCRIPTION OF DRAWINGS

FIG. 1 is a block diagram of a wireless communication system to which embodiments of this application are applicable;

FIG. 2 is a schematic diagram of verification of system information by using a digital signature according to an embodiment of this application;

FIG. 3 is a flowchart of an information processing method according to an embodiment of this application;

FIG. 4 is a flowchart of another information processing method according to an embodiment of this application;

FIG. 5 is a diagram of a structure of an information processing apparatus according to an embodiment of this application;

FIG. 6 is a diagram of a structure of another information processing apparatus according to an embodiment of this application;

FIG. 7 is a diagram of a structure of a communication device according to an embodiment of this application; and

FIG. 8 is a diagram of a structure of a terminal according to an embodiment of this application.

### DESCRIPTION OF EMBODIMENTS

The following clearly describes technical solutions in embodiments of this application with reference to the accompanying drawings in embodiments of this application. Apparently, the described embodiments are some but not all of embodiments of this application. All other embodiments obtained by a person of ordinary skill in the art based on embodiments of this application shall fall within the protection scope of this application.

The terms “first”, “second”, and the like in this specification and the claims of this application are used to distinguish between similar objects instead of describing a specific order or sequence. It should be understood that, the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, in this specification and the claims, “and/or” represents at least one of connected objects, and the character “/” generally represents an “or” relationship between associated objects.

It should be noted that the technologies described in embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” in embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to an application other than an NR system application, for example, a 6th generation (6G) communication system.

It can be learned that there is a problem of low security of terminal communication in a related technology.

Embodiments of this application provide an information processing method and apparatus, and a terminal, so that a problem of low security of terminal communication in a related technology can be resolved. In comparison with all parameters in the target information are directly applied in the conventional technology, this can reduce a case that the terminal completely applies system information sent by an illegal network-side device, causing the terminal to access the illegal network-side device or the terminal to be hijacked by the illegal network-side device, thereby improving security of terminal communication.

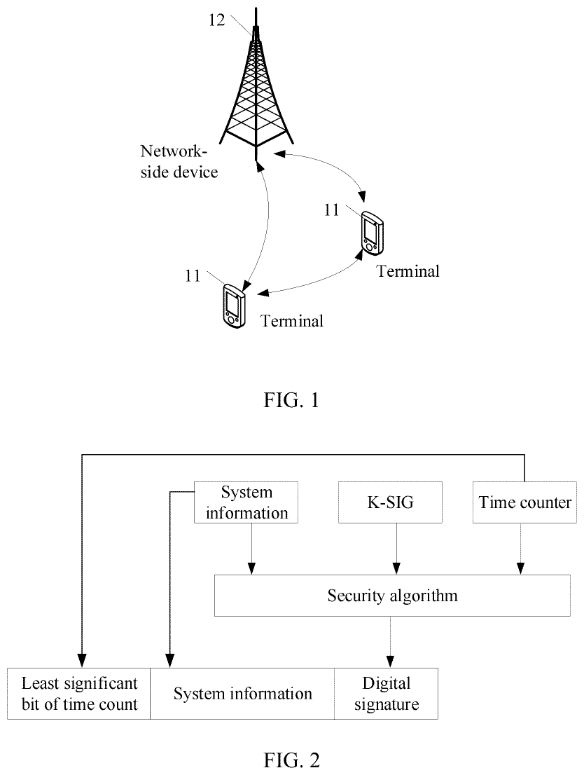

FIG. 1 is a block diagram of a wireless communication system to which embodiments of this application may be applied. The wireless communication system includes a terminal 11 and a network-side device 12. The terminal 11 may be a terminal-side device, for example, a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, or the like), a smart wrist strap, smart clothes, and the like. It should be noted that a specific type of the terminal 11 is not limited in embodiments of this application. The network-side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the art. The base station is not limited to a specific technical vocabulary provided that same technical effect is achieved. It should be noted that in embodiments of this application, a base station in an NR system is merely used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), a unified data management (UDM), a unified data repository (UDR), a home subscriber server (HSS), a centralized network configuration (CNC), a network repository function (NRF), a network exposure function (Network Exposure Function, NEF), a local NEF (L-NEF), a binding support function (BSF), an application function (AF), and the like. It should be noted that, in embodiments of this application, only a core network device in an NR system is used as an example for description, and a specific type of the core network device is not limited.

For ease of understanding, some content involved in embodiments of this application is described below.

### I. System Information

The system information (SI) includes a master information block (MIB) and a series of system information blocks (SIB), and may be divided into minimum system information (Minimum SI) and other system information (other SI).

The minimum SI includes basic information required for urban access and content of scheduling other SI. The following is included:
MIB: includes cell inhibition (bar) state information and cell essential physical layer information required for further receiving the system information; and
system information block 1 (SIB 1): indicates whether UE is allowed to access a cell and a scheduling information block of other SIBs.

Other SIBs are other SIBs that are not the minimum SI, for example, may include but are not limited to at least one of the following:
system information block 2 (SIB 2): is common information used by idle (idle)/inactive (inactive) UE to perform intra-frequency/inter-frequency/inter-system cell reselection;
system information block 3 (SIB 3): is dedicated information used by the idle/inactive UE to perform intra-frequency cell reselection;
system information block 4 (SIB 4): is dedicated information used by the idle/inactive UE to perform inter-frequency cell reselection; and
system information block 5 (SIB 5): is dedicated information used by the idle/inactive UE to perform inter-system cell reselection.

In addition to the SIB 1, another SIB may have the following features:

Each SIB is with a specific sending period, for example, 80 ms, 160 ms, or 320 ms. The sending period of each SIB is configurable, and is notified by a base station to a terminal.

A plurality of SIBs with a same sending period may form a system information message (SI message) for sending.

The SI message is sent in a predetermined sending window. The SI message is in a one-to-one correspondence with the window, to be specific, one SI message corresponds to one window, and only one SI message is sent in one window.

In one sending period, each SI message has one sending window, and the UE receives the SI message in the corresponding window.

Duration of the sending window of the SI message is configurable. However, in one cell (cell), duration of all windows of the SI message is the same.

Windows of different SI message are connected in a head-to-tail manner.

In the window, the base station may select one or more slots (slots) to send the SI message. In one window, the SI message sent may be combined by a hybrid automatic repeat request (HARQ) (for example, in one window, content of the SI message is unchangeable).

A mapping relationship between the another SIB and the SI message is configured by using the SIB 1. The SIB 1 further indicates a time position of a window of each SI message, that is, before obtaining the another SIB, the UE needs to first obtain the SIB 1.

### 2. Broadcast Message Security

In a mobile communication system, the base station sends system information in a broadcast manner. Content of the system information is sent in plaintext without security protection. If an illegal base station sends system information to indicate a terminal that camps on the illegal base station to perform some operations (for example, perform reselection based on a specified frequency priority), the terminal works according to an indication of the illegal base station. This causes a related policy configured by an operator to be invalid, and may even cause the UE to access the illegal base station, causing an unpredictable loss to a user. To avoid sending in this case, a digital signature needs to be signed on the system information, so that the UE verifies validity of the base station. If the system information protected by the digital signature changes, the corresponding digital signature also changes.

### 3. System Information Signature

As shown in FIG. 1, verification of the system information uses the following as input parameters: system information (SI), a signature key (K-SIG), related information of sending time (for example, a time counter (Time Counter)) of the SI, and the like, and an output result is a digital signature (DS) corresponding to the SI. In this way, system information broadcast by a network side corresponds to a digital signature and a least significant bit of time count (for example, LSB of Time Count), and the terminal determines whether the digital signature corresponding to the SI matches the digital signature corresponding to the SI broadcast by the network side to verify authenticity of the SI.

The following describes in detail an information processing method provided in embodiments of this application by using some embodiments and application scenarios thereof with reference to the accompanying drawings.

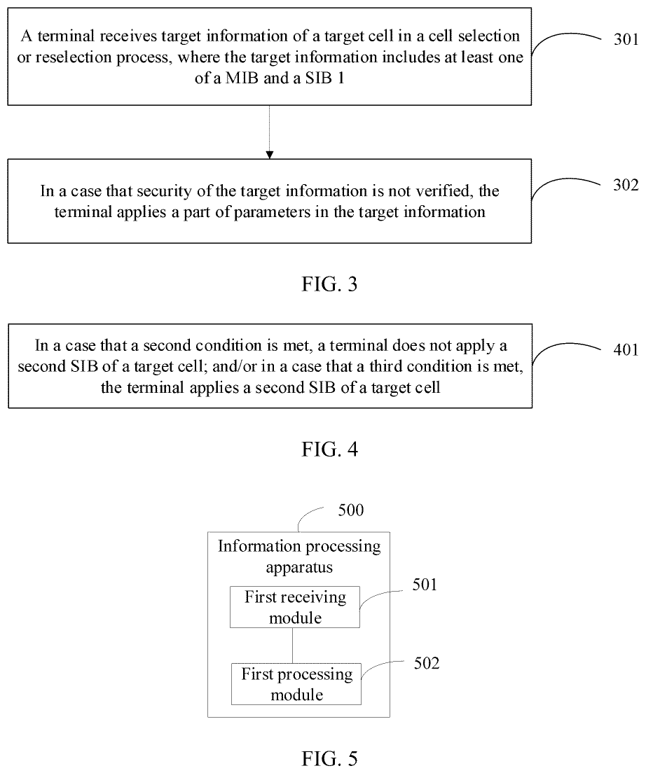

FIG. 3 is a flowchart of an information processing method according to an embodiment of this application. The method is performed by a terminal. As shown in FIG. 3, the method includes the following steps.

Step 301: The terminal receives target information of a target cell in a cell selection or reselection process, where the target information includes at least one of a MIB and a SIB 1.

The target cell may be any target cell determined in the cell selection or reselection process. For example, a cell whose signal strength meets a preset condition in a cell search process may be used as the target cell.

It should be noted that, in a case that the target cell includes the MIB and the SIB 1, the terminal may separately receive the MIB and the SIB 1 of the target cell. For example, the terminal may first receive the MIB of the target cell and then receive the SIB 1 of the target cell.

The MIB may include but is not limited to at least one of the following parameters: first cell inhibition (bar) state information, for example, a cell barred (cellBarred) parameter; cell essential physical layer information (namely, essential physical layer information of the cell) required for receiving the SIB 1; a parameter used to schedule the SIB 1, a position of the first demodulation reference signal (DMRS) for downlink and uplink (namely, position of first DM-RS for downlink and uplink); and the 6 most significant bits of the 10-bit system frame number (namely, the 6 most significant bits of the 10-bit System Frame Number).

The SIB 1 may include but is not limited to at least one of the following parameters: second cell inhibition state information, for example, a cell reserved for other use (namely, cellReservedForOtherUse) parameter, and a cell reserved for future use (namely, cellReservedForFutureUse) parameter; related information of an area to which a cell belongs, for example, a public land mobile network (PLMN) identifier (namely, plmn-Identity), a tracking area code (namely, trackingAreaCode), a RAN-based notification area code (RANAC), and a cell identity (namely, cellIdentity); a related parameter of a cell selection criterion, for example, a cell minimum reception level (namely, Qrxlevmin) and a minimum quality standard (namely, Qqualmin); and a parameter used to schedule other SIBs (namely, other SIBs), for example, a public access control parameter, and an emergency service support indication, used to indicate whether the cell supports an IP multimedia subsystem (IMS) emergency service of UE in a restricted service state.

Step 302: In a case that security of the target information is not verified, the terminal applies a part of parameters in the target information.

For example, in a case that the target information includes the MIB, the part of parameters in the target information may include a part of parameters in the MIB; in a case that the target information includes the SIB 1, the target information may include a part of parameters in the SIB 1; in a case that the target information includes the MIB and the SIB 1, the part of parameters in the target information may be understood as including only the MIB, or including only the SIB 1, or including at least one of a part of parameters in the MIB and a part of parameters in the SIB 1; or the like.

That the terminal applies the part of parameters in the target information may be understood as that the terminal uses the part of parameters in the target information, or the terminal performs corresponding processing or the like based on the part of parameters in the target information.

In this embodiment, in a case that security of the target information is not verified, that is, before the security of the target information is verified, the terminal first applies the part of parameters in the target information. For example, the terminal may determine whether to verify the security of the target information based on the part of parameters in the target information, so that some unnecessary verification performed by the terminal on system information can be reduced, thereby improving security of terminal communication, and reducing power consumption of the terminal; or the terminal may first perform some necessary processing based on the part of parameters in the target information, and then verify the target information, so that security of terminal communication can be improved, thereby ensuring efficiency of terminal information processing.

According to the information processing method provided by this embodiment of this application, the terminal receives the target information of the target cell in the cell selection or reselection process, where the target information includes at least one of the MIB and the SIB 1. In a case that the security of the target information is not verified, the terminal applies the part of parameters in the target information, that is, only the part of parameters in the target information are applied before the security of the target information is verified. In comparison with all parameters in the target information are directly applied in the conventional technology, this can reduce a case that the terminal applies system information sent by an illegal network-side device, thereby improving security of terminal communication.

Optionally, the part of parameters in the target information include at least one of the following: the part of parameters in the MIB and the part of parameters in the SIB 1;
the part of parameters in the MIB include at least one of the following: first cell inhibition state information, where the first cell inhibition state information is used to indicate a cell state; cell essential physical layer information required for receiving system information; and a parameter used to schedule the SIB 1; and
the part of parameters in the SIB 1 include at least one of the following: second cell inhibition state information, where the second cell inhibition state information is used to indicate a cell state; related information of an area to which a cell belongs; a related parameter of a cell selection criterion; and a parameter used to schedule another SIB.

The first cell inhibition (bar) state information is, for example, a cellBarred parameter. The cell essential physical layer information (namely, essential physical layer information of the cell) required for receiving the system information is, for example, cell essential physical layer information required for receiving the SIB 1. The parameter used to schedule the SIB 1 is, for example, pdcch-ConfigSIB1. pdcch-ConfigSIB1 is used to determine a control resource set (CORESET), a common search space, and a necessary physical downlink control channel (PDCCH) parameter.

The second cell inhibition state information is, for example, cellReservedForOtherUse parameter, or a cellReservedForFutureUse parameter. The related information of the area to which the cell belongs is, for example, plmn-Identity, trackingAreaCode, RANAC, or cellIdentity. The related parameter of the cell selection criterion (namely, an S criterion) is, for example, Qrxlevmin or Qqualmin. The parameter used to schedule the another SIB (namely, other SIBs) is, for example, a length of an SI scheduling window, or a scheduling period of an SI message.

In this embodiment, the part of parameters in the target information include at least one of the part of parameters in the MIB and the part of parameters in the SIB 1, the part of parameters in the MIB include at least one of the first cell inhibition state information, the cell essential physical layer information required for receiving the system information, and the parameter used to schedule the SIB 1, and the part of parameters in the SIB 1 include the second cell inhibition state information, the related information of the area to which the cell belongs, the related parameter of the cell selection criterion, and the parameter used to schedule the another SIB. In this way, the terminal can receive some necessary information and/or determine whether the target cell can be accessed based on the part of parameters in the target information, and then can verify or not verify the security of the target information based on a related processing result, so that security of terminal communication can be improved, thereby ensuring efficiency of terminal information processing, and reducing terminal consumption.

Optionally, that the terminal applies the part of parameters in the target information includes:

The terminal verifies or does not verify security of at least one of the MIB and the SIB 1 based on the part of parameters in the target information.

In this embodiment, the terminal can determine whether to verify the security of at least one of the MIB and the SIB 1 based on the part of parameters in the target information, so that some unnecessary verification performed by the terminal on the system information can be reduced, thereby improving security of terminal communication, and reducing power consumption of the terminal.

Optionally, that the terminal verifies or does not verify the security of at least one of the MIB and the SIB 1 based on the part of parameters in the target information includes at least one of the following:
in a case that the target cell does not meet the cell selection criterion, the terminal does not verify the security of at least one of the MIB and the SIB 1;
in a case that it is determined, based on at least one of the first cell inhibition state information and the second cell inhibition state information, that the target cell is in a barred state, the terminal performs security verification on the MIB and the SIB 1;
in a case that it is determined, based on at least one of the first cell inhibition state information and the second cell inhibition state information, that the target cell is not in a barred state, and the target cell meets the cell selection criterion, the terminal performs security verification on the MIB and the SIB 1; or
in a case that the target cell meets the cell selection criterion, the terminal performs security verification on the MIB and the SIB 1.

In an implementation, in a case that the part of parameters in the SIB 1 include the related parameter of the cell selection criterion, the terminal may not verify, in a case that the target cell does not meet the cell selection criterion, the security of at least one of the MIB and the SIB 1. For example, in a case that the target cell does not meet the cell selection criterion, the terminal may not verify the MIB and the SIB 1. In a case that the target cell does not meet the cell selection criterion, the terminal does not use the target cell as a candidate cell for cell selection or reselection, so that in this case, it is unnecessary to receive corresponding security information and verify the security of the MIB and the SIB 1. In this way, power consumption of the terminal can be reduced.

It should be noted that, in a case that the target cell does not meet the cell selection criterion, the terminal does not use the target cell as a candidate cell for cell selection or reselection. In this case, the terminal may receive target information of another target cell, and apply a part of parameters in the target information of the target cell in a case that security of the target information of the target cell is not verified. For example, in a case that a target cell A does not meet the cell selection criterion, the terminal does not use the target cell A as a candidate cell for cell selection or reselection. In this case, the terminal receives target information of a target cell B; and in a case that security of the target information of the target cell is not verified, applies a part of parameters in the target information of the target cell B, that is, determines whether the target cell B meets a cell selection criterion corresponding to the target cell B.

In another implementation, in a case that it may be determined, based on at least one of the first cell inhibition state information and the second cell inhibition state information, that the target cell is in a barred (namely, bar) state, the terminal performs security verification on the MIB and the SIB 1, so that the terminal can determine, based on a verification result, whether to apply a parameter, in the MIB, that is used to indicate whether the terminal can perform intra-frequency reselection. For the first cell inhibition state information and the second cell inhibition state information, refer to the related descriptions of the foregoing embodiments. Details are not described herein.

It should be noted that, in a case that it is determined, based on at least one of the first cell inhibition state information and the second cell inhibition state information, that the target cell is in a barred state, the terminal does not use the target cell as a candidate cell for cell selection or reselection.

In another implementation, in a case that it is determined, based on at least one of the first cell inhibition state information and the second cell inhibition state information, that the target cell is not in a barred state, and the target cell meets the cell selection criterion, the terminal performs security verification on the MIB and the SIB 1, and may further determine, based on a verification result, whether the terminal applies all parameters in the MIB and all parameters in the SIB 1, to reduce a case that illegal system information processing is performed by the terminal, thereby improving security of terminal communication.

In another implementation, in a case that the target cell meets the cell selection criterion, the terminal performs security verification on the MIB and the SIB 1, and may further determine, based on a verification result, whether the terminal applies all parameters in the MIB and all parameters in the SIB 1, to reduce a case that illegal system information processing is performed by the terminal, thereby improving security of terminal communication.

Optionally, that the terminal performs security verification on the MIB and the SIB 1 includes:
The terminal receives a first SIB by applying information for scheduling the first SIB in the SIB 1, where the first SIB includes security information used to verify the MIB and the SIB 1; and
the terminal performs security verification on the MIB and the SIB 1 based on the security information.

That the terminal receives the first SIB by applying the information for scheduling the first SIB in the SIB 1 may be understood as that the terminal receives the first SIB based on the information for scheduling the first SIB in the SIB 1, or the terminal receives the first SIB by using the information for scheduling the first SIB in the SIB 1.

Security information of the MIB and security information of the SIB 1 may be different security information. For example, the first SIB includes security information A and security information B, the security information A is used to verify the MIB, and the security information B is used to verify the SIB 1. Alternatively, security information of the MIB and security information of the SIB 1 may be same security information. For example, the first SIB includes security information C, and the security information C is used to verify the MIB and the SIB 1. The security information may include, for example, a digital signature or signature information. The first SIB may be another SIB (namely, other SIBs). For example, the first SIB may include at least one of an existing SIB 2, an existing SIB 3, an existing SIB 4, and the like, or may be a newly introduced SIB dedicated to carrying the security information.

The terminal performs security verification on the MIB based on the security information. For example, the terminal may compare the received security information (namely, the security information carried in the first SIB) with the security information corresponding to the MIB calculated by the terminal. If the two pieces of security information match, it is determined that the MIB succeeds in security verification; otherwise, it is determined that the MIB fails in security verification. The terminal performs security verification on the SIB 1 based on the security information. For example, the terminal may compare the received security information with the security information corresponding to the SIB 1 calculated by the terminal. If the two pieces of security information match, it is determined that the SIB 1 succeeds in security verification; otherwise, it is determined that the SIB 1 fails in security verification.

It should be noted that the security verification may also be referred to as authenticity verification, or may be referred to as verification on the signature information. The MIB and the SIB 1 may be protected system information. For example, a network-side device provides or broadcasts security information or signature information associated with the MIB and the SIB 1, or a network-side device provides or broadcasts security information or signature information used to verify the MIB and the SIB 1.

In this embodiment, the terminal receives the first SIB based on first information for scheduling the first SIB in the SIB 1, where the first SIB includes the security information used to verify the MIB and the SIB 1; and performs security verification on the MIB and the SIB 1 based on the security information. In this way, security verification on the MIB and the SIB 1 can be easily implemented, and reliability of the verification result can be ensured.

Optionally, that the terminal performs security verification on the MIB and the SIB 1 based on the security information includes:

In a case that a first condition is met, the terminal performs security verification on the MIB and the SIB 1 based on the security information, where
the first condition includes at least one of the following:
an area to which the target cell belongs is in an effective area corresponding to a security key configured for the terminal; and
within effective time corresponding to the security key configured for the terminal.

The security key may include a key used for encrypting a broadcast message and/or a key used for signing the broadcast message, and the security key may be preconfigured or updated by a core network.

The effective area corresponding to the security key may include at least one of a tracking area (TA), an access network notification area (RAN-based Notification Area, RANA), and a cell.

The effective time corresponding to the security key may be absolute time, where for example, the security key takes effect at 15:00 on August 22 (UTC August 22 15:00); or may be relative time, where for example, the security key takes effect 10 hours after the UE receives a plurality of sets of security parameter configurations sent by the network-side device.

In this embodiment, in a case that the first condition is met, the terminal performs security verification on the MIB and the SIB 1 based on the security information, so that reliability of the verification result can be improved.

Optionally, in a case that it is determined, based on at least one of the first cell inhibition state information and the second cell inhibition state information, that the target cell is in the barred state, the method further includes:

In a case that the MIB succeeds in security verification, the terminal applies a first parameter of the MIB, where the first parameter is used to indicate whether the terminal can perform intra-frequency reselection.

In this embodiment, in a case that it is determined, based on at least one of the first cell inhibition state information and the second cell inhibition state information, that the target cell is in the barred state, if the MIB succeeds in security verification, the terminal may apply the first parameter of the MIB to determine whether intra-frequency reselection can be performed. It should be noted that, in a case that the MIB fails in security verification, the terminal does not apply the parameter of the MIB to determine whether to perform intra-frequency reselection, and considers that intra-frequency reselection can be performed.

Optionally, in a case that the target cell meets the cell selection criterion, or in a case that it is determined, based on at least one of the first cell inhibition state information and the second cell inhibition state information, that the target cell is not in the barred state, and the target cell meets the cell selection criterion, the method further includes at least one of the following:
In a case that at least one of the MIB and the SIB 1 fails in security verification, the terminal does not use the target cell as a candidate cell for cell selection or reselection; or
in a case that the MIB and the SIB 1 both succeed in security verification, the terminal performs at least one of the following:
selecting or reselecting or camping to the target cell;
applying all parameters in the MIB and all parameters in the SIB 1; and
applying a remaining parameter in the MIB and a remaining parameter in the SIB 1, where the remaining parameter in the MIB includes a parameter other than the part of parameters in the MIB in all the parameters in the MIB, and the remaining parameter in the SIB 1 includes a parameter other than the part of parameters in the SIB 1 in all the parameters in the SIB 1, where
the terminal supports all the parameters in the MIB and all the parameters in the SIB 1.

The part of parameters in the MIB may be understood as parameters in the MIB that are applied before the MIB and the SIB 1 are verified. For specific content, refer to the related descriptions of the part of parameters in the MIB in the foregoing embodiments. The part of parameters in the SIB 1 may be understood as parameters in the SIB 1 that are applied before the MIB and the SIB 1 are verified. For specific content, refer to the related descriptions of the part of parameters in the SIB 1 in the foregoing embodiments.

In this embodiment, in a case that the target cell meets the cell selection criterion, or in a case that it is determined, based on at least one of the first cell inhibition state information and the second cell inhibition state information, that the target cell is not in the barred state, and the target cell meets the cell selection criterion, if at least one of the MIB and the SIB 1 fails in security verification, the terminal does not use the target cell as the candidate cell for cell selection or reselection, to prevent the terminal from accessing an illegal cell. If the MIB and the SIB 1 both succeed in security verification, it indicates that the security of the target cell is high, and the terminal may select or reselect or camp on the target cell, so that security of accessing the cell by the terminal can be ensured. In addition, if the MIB and the SIB 1 both succeed in security verification, all the parameters in the MIB and all the parameters in the SIB 1 may be applied, or the remaining parameter in the MIB and the remaining parameter in the SIB 1 may be applied, so that a case that the terminal applies illegal system information can be reduced, thereby improving security of terminal communication.

Optionally, the method further includes:
In a case that a second condition is met, the terminal does not apply a second SIB of the target cell, where the second condition includes at least one of the following: security verification on the MIB has not been performed, security verification on the SIB 1 has not been performed, the MIB fails in security verification, and the SIB 1 fails in security verification; the terminal does not receive a third SIB, and the third SIB includes security information used to verify the second SIB; and the second SIB fails in security verification; and/or
in a case that a third condition is met, the terminal applies a second SIB of the target cell, where the third condition includes at least one of the following: the MIB, the SIB 1, and the second SIB all succeed in security verification, and the second SIB succeeds in security verification.

In this embodiment, the second SIB may be another SIB. For example, the second SIB may include at least one of a SIB 2, a SIB 3, a SIB 4, and the like. The third SIB may also be another SIB. For example, the third SIB may also include at least one of an existing SIB 2, an existing SIB 3, an existing SIB 4, and the like, or is a newly introduced SIB dedicated to carrying the security information.

It should be noted that the first SIB and the third SIB may be a same SIB, where for example, the first SIB and the third SIB both may be a SIB 2; or the first SIB and the third SIB may be different SIBs, where for example, the first SIB is a SIB 2, and the third SIB may be a SIB 3.

Specifically, in a case that the terminal receives the second SIB of the target cell, the terminal may not process or apply the second SIB in a case that the second condition is met, and/or the terminal processes or applies the second SIB in a case that the third condition is met. In this way, a case that the terminal processes illegal system information can be reduced, thereby reducing power consumption of the terminal.

It should be noted that the MIB, the SIB 1, and the second SIB in this embodiment all may be protected SIBs. The protected SIB may understand that the network-side device broadcasts or provides security information associated with the protected SIB.

Optionally, the method further includes:
In a case that a fourth condition is met, the terminal does not receive a second SIB of the target cell, where the fourth condition includes at least one of the following: security verification on the MIB has not been performed, security verification on the SIB 1 has not been performed, the MIB fails in security verification, and the SIB 1 fails in security verification; and the terminal does not receive a third SIB, and the third SIB includes security information used to verify the second SIB; and/or
in a case that a fifth condition is met, the terminal receives a second SIB of the target cell, where the fifth condition includes: the MIB and the SIB 1 both succeed in security verification.

In this embodiment, in a case that the fourth condition is met, the terminal does not receive the second SIB of the target cell; and/or in a case that the fifth condition is met, the terminal receives the second SIB of the target cell. In this way, a case that the terminal receives some unnecessary or illegal system information can be reduced, thereby reducing power consumption of the terminal.

It should be noted that the terminal does not apply the second SIB of the target cell in a case that the second condition is met; and/or the terminal applies the second SIB of the target cell in a case that the third condition is met, which may be combined with that the terminal does not receive the second SIB of the target cell in a case that the fourth condition is me; and/or the terminal receives the second SIB of the target cell in a case that the fifth condition is met. For example, the terminal may first determine whether to receive the second SIB of the target cell. Specifically, the terminal does not receive the second SIB of the target cell in a case that the fourth condition is met; and the terminal receives the second SIB of the target cell in a case that the fifth condition is met. Further, in a case that the terminal receives the second SIB of the target cell, the terminal can determine whether to apply the received second SIB. Specifically, in a case that the second condition is met, the terminal does not apply the received second SIB; or in a case that the third condition is met, the terminal applies the received second SIB.

Optionally, the terminal meets at least one of the following:
having a system information security verification capability;
being configured to perform system information security verification; and
being configured with a parameter used for system information security verification, where the parameter includes at least one of the following:
a security key used for system information security verification;
an effective area corresponding to the security key; and
effective time corresponding to the security key.

In this embodiment, the terminal may have the system information security verification capability, that is, the terminal supports security verification on the system information. The terminal is configured to perform system information security verification, that is, the terminal is configured to perform security verification on the received system information.

The security key used for system information security verification may include a key used for encrypting a broadcast message and/or a key used for signing a broadcast message. The effective area corresponding to the security key may include at least one of a TA, a RANA, and a cell. The effective time corresponding to the security key may be absolute time or relative time.

FIG. 4 is a flowchart of an information processing method according to an embodiment of this application. The method is performed by a terminal. As shown in FIG. 4, the method includes the following steps.

Step 401: In a case that a second condition is met, the terminal does not apply a second SIB of a target cell; and/or in a case that a third condition is met, the terminal applies a second SIB of a target cell.

The second condition includes at least one of the following: security verification on a MIB of the target cell has not been performed, security verification on a SIB 1 of the target cell has not been performed, the MIB fails in security verification, and the SIB 1 fails in security verification; the terminal does not receive a third SIB, and the third SIB includes security information used to verify the second SIB; and the second SIB fails in security verification.

The third condition includes at least one of the following: the MIB, the SIB 1, and the second SIB all succeed in security verification, and the second SIB succeeds in security verification.

Optionally, the method further includes:
In a case that a fourth condition is met, the terminal does not receive the second SIB, where the fourth condition includes at least one of the following: security verification on the MIB has not been performed, security verification on the SIB 1 has not been performed, the MIB fails in security verification, and the SIB 1 fails in security verification; and the terminal does not receive the third SIB, and the third SIB includes the security information used to verify the second SIB; and/or
in a case that a fifth condition is met, the terminal receives the second SIB, where the fifth condition includes: the MIB and the SIB 1 both succeed in security verification.

Optionally, the terminal meets at least one of the following:
having a system information security verification capability;
being configured to perform system information security verification; and
being configured with a parameter used for system information security verification, where the parameter includes at least one of the following:
a security key used for system information security verification;
an effective area corresponding to the security key; and
effective time corresponding to the security key.

It should be noted that for an implementation of this implementation, refer to related descriptions of the embodiment shown in FIG. 3. Details are not described herein again.

It should be noted that, the information processing method provided in embodiments of this application may be performed by an information processing apparatus, or a control module in the information processing apparatus for performing the information processing method. In embodiments of this application, that the information processing apparatus performs the information processing method is used as an example to describe the information processing apparatus provided in embodiments of this application.

FIG. 5 is a diagram of a structure of an information processing apparatus according to an embodiment of this application. The information processing apparatus is used in a terminal. As shown in FIG. 5, the information processing apparatus 500 includes:
a first receiving module 501, configured to receive target information of a target cell in a cell selection or reselection process, where the target information includes at least one of a master information block MIB and a system information block SIB 1; and
a first processing module 502, configured to: in a case that security of the target information is not verified, apply a part of parameters in the target information.

Optionally, the part of parameters in the target information include at least one of the following: a part of parameters in the MIB and a part of parameters in the SIB 1;
the part of parameters in the MIB include at least one of the following: first cell inhibition state information, where the first cell inhibition state information is used to indicate a cell state; cell essential physical layer information required for receiving system information; and a parameter used to schedule the SIB 1; and
the part of parameters in the SIB 1 include at least one of the following: second cell inhibition state information, where the second cell inhibition state information is used to indicate a cell state; related information of an area to which a cell belongs; a related parameter of a cell selection criterion; and a parameter used to schedule another SIB.

Optionally, the first processing module 502 is specifically configured to:
verify or not verify security of at least one of the MIB and the SIB 1 based on the part of parameters in the target information.

Optionally, the first processing module 502 is specifically configured to perform at least one of the following:
in a case that the target cell does not meet the cell selection criterion, not verifying the security of at least one of the MIB and the SIB 1;
in a case that it is determined, based on at least one of the first cell inhibition state information and the second cell inhibition state information, that the target cell is in a barred state, performing security verification on the MIB and the SIB 1;
in a case that it is determined, based on at least one of the first cell inhibition state information and the second cell inhibition state information, that the target cell is not in a barred state, and the target cell meets the cell selection criterion, performing security verification on the MIB and the SIB 1; or
in a case that the target cell meets the cell selection criterion, performing security verification on the MIB and the SIB 1.

Optionally, the first processing module 502 is specifically configured to:
receive a first SIB by applying information for scheduling the first SIB in the SIB 1, where the first SIB includes security information used to verify the MIB and the SIB 1; and
perform, by the terminal, security verification on the MIB and the SIB 1 based on the security information.

Optionally, the first processing module 502 is specifically configured to:
in a case that a first condition is met, perform security verification on the MIB and the SIB 1 based on the security information, where
the first condition includes at least one of the following:
an area to which the target cell belongs is in an effective area corresponding to a security key configured for the terminal; and
within effective time corresponding to the security key configured for the terminal.

Optionally, the apparatus 500 further includes:
a second processing module, configured to: in a case that the MIB succeeds in security verification, apply a first parameter of the MIB, where the first parameter is used to indicate whether the terminal can perform intra-frequency reselection.

Optionally, the apparatus 500 further includes a third processing module, configured to perform at least one of the following:
in a case that at least one of the MIB and the SIB 1 fails in security verification, not using the target cell as a candidate cell for cell selection or reselection; or
in a case that the MIB and the SIB 1 both succeed in security verification, performing at least one of the following:
selecting or reselecting or camping to the target cell;
applying all parameters in the MIB and all parameters in the SIB 1, where all the parameters in the MIB are parameters supported by the terminal, and all the parameters in the SIB 1 are parameters supported by the terminal; and
applying a remaining parameter in the MIB and a remaining parameter in the SIB 1, where the remaining parameter in the MIB includes a parameter other than the part of parameters in the MIB in all the parameters in the MIB, and the remaining parameter in the SIB 1 includes a parameter other than the part of parameters in the SIB 1 in all the parameters in the SIB 1, where
the terminal supports all the parameters in the MIB and all the parameters in the SIB 1.

Optionally, the apparatus 500 further includes:
a fourth processing module, configured to: in a case that a second condition is met, not apply a second SIB of the target cell; and/or in a case that a third condition is met, apply a second SIB of the target cell, where
the second condition includes at least one of the following: security verification on the MIB has not been performed, security verification on the SIB 1 has not been performed, the MIB fails in security verification, and the SIB 1 fails in security verification; the terminal does not receive a third SIB, and the third SIB includes security information used to verify the second SIB; and the second SIB fails in security verification; and
the third condition includes at least one of the following: the MIB, the SIB 1, and the second SIB all succeed in security verification, and the second SIB succeeds in security verification.

Optionally, the apparatus 500 further includes a second receiving module, and the second receiving module is configured to:
in a case that a fourth condition is met, not receive a second SIB, where the fourth condition includes at least one of the following: security verification on the MIB has not been performed, security verification on the SIB 1 has not been performed, the MIB fails in security verification, and the SIB 1 fails in security verification; and the terminal does not receive a third SIB, and the third SIB includes security information used to verify the second SIB; and/or
in a case that a fifth condition is met, receive a second SIB, where the fifth condition includes: the MIB and the SIB 1 both succeed in security verification.

Optionally, the terminal meets at least one of the following:
having a system information security verification capability;
being configured to perform system information security verification; and
being configured with a parameter used for system information security verification, where the parameter includes at least one of the following:
a security key used for system information security verification;
an effective area corresponding to the security key; and
effective time corresponding to the security key.

The information processing apparatus in this embodiment of this application may be an electronic device, for example, an electronic device with an operating system, or may be a component in the electronic device, for example, an integrated circuit or a chip. The electronic device may be a terminal, or a device other than the terminal. For example, the terminal may include but is not limited to the foregoing listed types of the terminal 11, and the another device may be a server, a network attached storage (NAS), or the like. This is not specifically limited in this embodiment of this application.

The information processing apparatus provided in this embodiment of this application can implement the processes implemented in the method embodiment in FIG. 3, and same technical effect can be achieved. To avoid repetition, details are not described herein again.

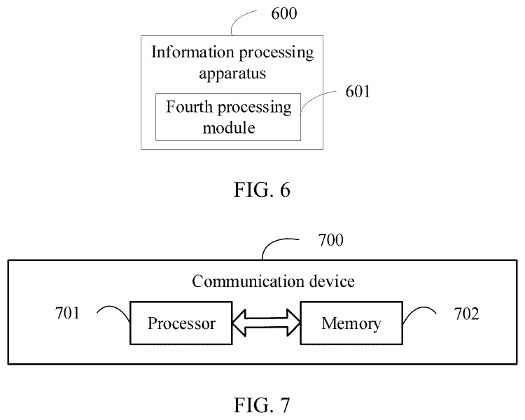

FIG. 6 is a diagram of a structure of an information processing apparatus according to an embodiment of this application. The information processing apparatus is used in a terminal. As shown in FIG. 6, the information processing apparatus 600 includes:
a fourth processing module 601, configured to: in a case that a second condition is met, not apply a second system information block SIB of a target cell; and/or in a case that a third condition is met, apply a second SIB of a target cell, where
the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and
the third condition includes at least one of the following: the MIB, the SIB 1, and the second SIB all succeed in security verification, and the second SIB succeeds in security verification.

Optionally, the apparatus 600 further includes a second receiving module, and the second receiving module is configured to:
in a case that a fourth condition is met, not receive the second SIB, where the fourth condition includes at least one of the following: security verification on the MIB has not been performed, security verification on the SIB 1 has not been performed, the MIB fails in security verification, and the SIB 1 fails in security verification; and the terminal does not receive the third SIB, and the third SIB includes the security information used to verify the second SIB; and/or
in a case that a fifth condition is met, receive the second SIB, where the fifth condition includes: the MIB and the SIB 1 both succeed in security verification.

Optionally, the terminal meets at least one of the following:
having a system information security verification capability;
being configured to perform system information security verification; and
being configured with a parameter used for system information security verification, where the parameter includes at least one of the following:
a security key used for system information security verification;
an effective area corresponding to the security key; and
effective time corresponding to the security key.

The information processing apparatus in this embodiment of this application may be an electronic device, for example, an electronic device with an operating system, or may be a component in the electronic device, for example, an integrated circuit or a chip. The electronic device may be a terminal, or a device other than the terminal. For example, the terminal may include but is not limited to the foregoing listed types of the terminal 11, and the another device may be a server, a network attached storage (NAS), or the like. This is not specifically limited in this embodiment of this application.

The information processing apparatus provided in this embodiment of this application can implement the processes implemented in the method embodiment in FIG. 4, and same technical effect can be achieved. To avoid repetition, details are not described herein again.

Optionally, as shown in FIG. 7, an embodiment of this application further provides a communication device 700. The communication device 700 includes a processor 701 and a memory 702. The memory 702 stores a program or an instruction that can be run on the processor 701. For example, when the communication device 700 is a terminal, the program or the instruction is executed by the processor 701 to implement the steps of the foregoing information processing method embodiments, and same technical effect can be achieved. To avoid repetition, details are not described herein again.

An embodiment of this application further provides a terminal. The terminal includes a processor and a communication interface. The communication interface is configured to receive target information of a target cell in a cell selection or reselection process, where the target information includes at least one of a MIB or a SIB 1; and the processor is configured to: in a case that security of the target information is not verified, apply a part of parameters in the target information; or
the processor is configured to: in a case that a second condition is met, not apply a second system information block SIB of the target cell; and/or in a case that a third condition is met, apply a second SIB of the target cell, where the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and the third condition includes at least one of the following: the MIB, the SIB 1, and the second SIB all succeed in security verification, and the second SIB succeeds in security verification.

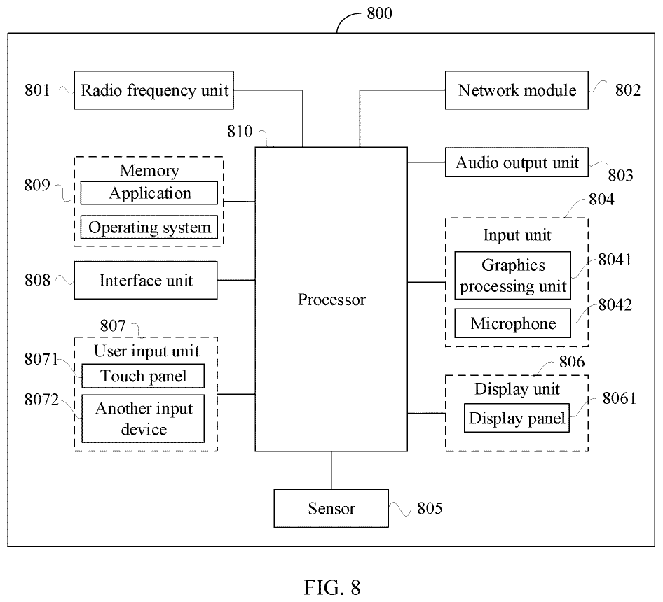

The terminal embodiment corresponds to the method embodiment on the terminal side, each implementation process and implementation of the method embodiment can be applied to the terminal embodiment, and same technical effect can be achieved. Specifically, FIG. 8 is a schematic diagram of a hardware structure of a terminal according to an embodiment of this application.

The terminal 800 includes but is not limited to at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the terminal 800 may further include a power supply (such as a battery) that supplies power to each component. The power supply may be logically connected to the processor 810 by using a power supply management system, to implement functions such as charging and discharging management, and power consumption management by using the power supply management system. The terminal structure shown in FIG. 8 constitutes no limitation on the terminal, and the terminal may include more or fewer components than those shown in the figure, or combine some components, or have different component arrangements. Details are not described herein.

It should be understood that in this embodiment of this application, the input unit 804 may include a graphics processing unit (GPU) 8041 and a microphone 8042. The graphics processing unit 8041 processes image data of a static picture or a video obtained by an image capture apparatus (for example, a camera) in a video capture mode or an image capture mode. The display unit 806 may include a display panel 8061, and the display panel 8061 may be configured in a form of a liquid crystal display, an organic light-emitting diode, or the like. The user input unit 807 includes at least one of a touch panel 8071 and another input device 8072. The touch panel 8071 is also referred to as a touchscreen. The touch panel 8071 may include two parts: a touch detection apparatus and a touch controller. The another input device 8072 may include but is not limited to a physical keyboard, a functional button (such as a volume control button or a power on/off button), a trackball, a mouse, and a joystick. Details are not described herein.

In this embodiment of this application, after receiving downlink data from a network-side device, the radio frequency unit 801 may transmit the downlink data to the processor 810 for processing. In addition, the radio frequency unit 801 may send uplink data to the network-side device. Usually, the radio frequency unit 801 includes but is not limited to an antenna, an amplifier, a transceiver, a coupler, a low noise amplifier, a duplexer, and the like.

The memory 809 may be configured to store a software program or an instruction and various data. The memory 809 may mainly include a first storage area for storing a program or an instruction and a second storage area for storing data. The first storage area may store an operating system, and an application or an instruction required by at least one function (for example, a sound playing function or an image playing function). In addition, the memory 809 may include at least one of a volatile memory, a non-volatile memory, a transient memory, and a non-transient memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 809 in this embodiment of this application includes but is not limited to these memories and any memory of another proper type.

The processor 810 may include one or more processing units. Optionally, an application processor and a modem processor are integrated into the processor 810. The application processor mainly processes an operating system, a user interface, an application, or the like. The modem processor mainly processes a wireless communication signal, for example, a baseband processor. It may be understood that, alternatively, the modem processor may not be integrated into the processor 810.

The radio frequency unit 801 is configured to: receive target information of a target cell in a cell selection or reselection process, where the target information includes at least one of a MIB and a SIB 1; and
the processor 810 is configured to: in a case that security of the target information is not verified, apply a part of parameters in the target information; or
the processor 810 is configured to: in a case that a second condition is met, not apply a second system information block SIB of the target cell; and/or in a case that a third condition is met, apply a second SIB of the target cell, where the second condition includes at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB includes security information used to verify the second SIB; and the second SIB fails in security verification; and the third condition includes at least one of the following: the MIB, the SIB 1, and the second SIB all succeed in security verification, and the second SIB succeeds in security verification.

It should be noted that each implementation process and implementation of the foregoing method embodiment can be applied to the terminal embodiment, and same technical effect can be achieved.

An embodiment of this application further provides a readable storage medium. The readable storage medium stores a program or an instruction; and when the program or the instruction is executed by a processor, the processes of the information processing method embodiment are implemented, and same technical effect can be achieved. To avoid repetition, details are not described herein again.

The processor is a processor in the terminal in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, the communication interface is coupled to the processor, the processor is configured to run a program or an instruction to implement the processes of the information processing method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the program/program product is executed by at least one processor to implement the processes of the foregoing information processing method embodiment, and same technical effect can be achieved. To avoid repetition, details are not described herein again.

An embodiment of this application further provides an information processing system. The information processing system includes a terminal and a network-side device. The terminal is configured to perform the processes in FIG. 3 and the foregoing method embodiments, or the terminal is configured to perform the processes in FIG. 4 and the foregoing method embodiments, and same technical effect can be achieved. To avoid repetition, details are not described herein again.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are merely examples, but are not limitative. Under the enlightenment of this application, a person of ordinary skill in the art may further make many forms without departing from the purpose of this application and the protection scope of the claims, and all the forms fall within the protection of this application.

1. An information processing method, comprising:
receiving, by a terminal, target information of a target cell in a cell selection or reselection process, wherein the target information comprises at least one of a master information block MIB or a system information block SIB 1; and
in a case that security of the target information is not verified, applying, by the terminal, a part of parameters in the target information.

2. The method according to claim 1, wherein the part of parameters in the target information comprise at least one of the following: a part of parameters in the MIB or a part of parameters in the SIB 1;
the part of parameters in the MIB comprise at least one of the following: first cell inhibition state information, wherein the first cell inhibition state information is used to indicate a cell state; cell essential physical layer information required for receiving system information; or a parameter used to schedule the SIB 1; and
the part of parameters in the SIB 1 comprise at least one of the following: second cell inhibition state information, wherein the second cell inhibition state information is used to indicate a cell state; related information of an area to which a cell belongs; a related parameter of a cell selection criterion; or a parameter used to schedule another SIB.

3. The method according to claim 1, wherein the applying, by the terminal, a part of parameters in the target information comprises:
verifying or not verifying, by the terminal, security of at least one of the MIB or the SIB 1 based on the part of parameters in the target information.

4. The method according to claim 3, wherein the verifying or not verifying, by the terminal, security of at least one of the MIB or the SIB 1 based on the part of parameters in the target information comprises at least one of the following:
in a case that the target cell does not meet the cell selection criterion, not verifying, by the terminal, the security of at least one of the MIB or the SIB 1;
in a case that it is determined, based on at least one of the first cell inhibition state information or the second cell inhibition state information, that the target cell is in a barred state, performing, by the terminal, security verification on the MIB and the SIB 1;
in a case that it is determined, based on at least one of the first cell inhibition state information or the second cell inhibition state information, that the target cell is not in a barred state, and the target cell meets the cell selection criterion, performing, by the terminal, security verification on the MIB and the SIB 1; or
in a case that the target cell meets the cell selection criterion, performing, by the terminal, security verification on the MIB and the SIB 1.

5. The method according to claim 4, wherein the performing, by the terminal, security verification on the MIB and the SIB 1 comprises:
receiving, by the terminal, a first SIB by applying information for scheduling the first SIB in the SIB 1, wherein the first SIB comprises security information used to verify the MIB and the SIB 1; and
performing, by the terminal, security verification on the MIB and the SIB 1 based on the security information.

6. The method according to claim 5, wherein the performing, by the terminal, security verification on the MIB and the SIB 1 based on the security information comprises:
in a case that a first condition is met, performing, by the terminal, security verification on the MIB and the SIB 1 based on the security information, wherein
the first condition comprises at least one of the following:
an area to which the target cell belongs is in an effective area corresponding to a security key configured for the terminal; or
within effective time corresponding to the security key configured for the terminal.

7. The method according to claim 4, wherein in a case that it is determined, based on at least one of the first cell inhibition state information or the second cell inhibition state information, that the target cell is in the barred state, the method further comprises:
in a case that the MIB succeeds in security verification, applying, by the terminal, a first parameter of the MIB, wherein the first parameter is used to indicate whether the terminal can perform intra-frequency reselection.

8. The method according to claim 4, wherein in a case that the target cell meets the cell selection criterion, or in a case that it is determined, based on at least one of the first cell inhibition state information or the second cell inhibition state information, that the target cell is not in the barred state, and the target cell meets the cell selection criterion, the method further comprises at least one of the following:
in a case that at least one of the MIB or the SIB 1 fails in security verification, not using, by the terminal, the target cell as a candidate cell for cell selection or reselection; or
in a case that the MIB and the SIB 1 both succeed in security verification, performing, by the terminal, at least one of the following:
selecting or reselecting or camping to the target cell;
applying all parameters in the MIB and all parameters in the SIB 1; or
applying a remaining parameter in the MIB and a remaining parameter in the SIB 1, wherein the remaining parameter in the MIB comprises a parameter other than the part of parameters in the MIB in all the parameters in the MIB, and the remaining parameter in the SIB 1 comprises a parameter other than the part of parameters in the SIB 1 in all the parameters in the SIB 1, wherein
the terminal supports all the parameters in the MIB and all the parameters in the SIB 1.

9. The method according to claim 1, wherein the method further comprises:
in a case that a second condition is met, not applying, by the terminal, a second SIB of the target cell, wherein the second condition comprises at least one of the following: security verification on the MIB has not been performed, security verification on the SIB 1 has not been performed, the MIB fails in security verification, and the SIB 1 fails in security verification; the terminal does not receive a third SIB, and the third SIB comprises security information used to verify the second SIB; or the second SIB fails in security verification; and/or
in a case that a third condition is met, applying, by the terminal, a second SIB of the target cell, wherein the third condition comprises at least one of the following: the MIB, the SIB 1, and the second SIB all succeed in security verification, or the second SIB succeeds in security verification.

10. The method according to claim 1, wherein the method further comprises:
in a case that a fourth condition is met, not receiving, by the terminal, a second SIB of the target cell, wherein the fourth condition comprises at least one of the following: security verification on the MIB has not been performed, security verification on the SIB 1 has not been performed, the MIB fails in security verification, and the SIB 1 fails in security verification; and the terminal does not receive a third SIB, or the third SIB comprises security information used to verify the second SIB; and/or
in a case that a fifth condition is met, receiving, by the terminal, a second SIB of the target cell, wherein the fifth condition comprises: the MIB and the SIB 1 both succeed in security verification.

11. The method according to claim 1, wherein the terminal meets at least one of the following:
having a system information security verification capability;
being configured to perform system information security verification; or
being configured with a parameter used for system information security verification, wherein the parameter comprises at least one of the following:
a security key used for system information security verification;
an effective area corresponding to the security key; or
effective time corresponding to the security key.

12. An information processing method, comprising:
in a case that a second condition is met, not applying, by a terminal, a second system information block SIB of a target cell, wherein
the second condition comprises at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB comprises security information used to verify the second SIB; or the second SIB fails in security verification; and/or
in a case that a third condition is met, applying, by the terminal, a second SIB of a target cell, wherein the third condition comprises at least one of the following: a MIB, a SIB 1, and the second SIB all succeed in security verification, or the second SIB succeeds in security verification.

13. The method according to claim 12, wherein the method further comprises:
in a case that a fourth condition is met, not receiving, by the terminal, the second SIB, wherein the fourth condition comprises at least one of the following: security verification on the MIB has not been performed, security verification on the SIB 1 has not been performed, the MIB fails in security verification, and the SIB 1 fails in security verification; and the terminal does not receive the third SIB, or the third SIB comprises the security information used to verify the second SIB; and/or
in a case that a fifth condition is met, receiving, by the terminal, the second SIB, wherein the fifth condition comprises: the MIB and the SIB 1 both succeed in security verification.

14. The method according to claim 12, wherein the terminal meets at least one of the following:
having a system information security verification capability;
being configured to perform system information security verification; or
being configured with a parameter used for system information security verification, wherein the parameter comprises at least one of the following:
a security key used for system information security verification;
an effective area corresponding to the security key; or
effective time corresponding to the security key.

15. A terminal, comprising a processor and a memory, wherein the memory stores a program or an instruction that can be run on the processor; and when the program or the instruction is executed by the processor, the steps of an information processing method is implemented,
wherein the information processing method comprises:
receiving, by the terminal, target information of a target cell in a cell selection or reselection process, wherein the target information comprises at least one of a master information block MIB or a system information block SIB 1; and
in a case that security of the target information is not verified, applying, by the terminal, a part of parameters in the target information,
or wherein the information processing method comprises:
in a case that a second condition is met, not applying, by the terminal, a second system information block SIB of a target cell, wherein
the second condition comprises at least one of the following: security verification on a master information block MIB of the target cell has not been performed, security verification on a system information block SIB 1 of the target cell has not been performed, the MIB fails in security verification, and the SIB 1 fails in security verification; the terminal does not receive a third SIB, and the third SIB comprises security information used to verify the second SIB; or the second SIB fails in security verification; and/or
in a case that a third condition is met, applying, by the terminal, a second SIB of a target cell, wherein the third condition comprises at least one of the following: a MIB, a SIB 1, and the second SIB all succeed in security verification, or the second SIB succeeds in security verification.

16. A non-transitory readable storage medium, wherein the readable storage medium stores a program or an instruction; and when the program or the instruction is executed by a processor, the steps of the information processing method according to claim 1.

17. The non-transitory readable storage medium according to claim 16, wherein the part of parameters in the target information comprise at least one of the following: a part of parameters in the MIB or a part of parameters in the SIB 1;
the part of parameters in the MIB comprise at least one of the following: first cell inhibition state information, wherein the first cell inhibition state information is used to indicate a cell state; cell essential physical layer information required for receiving system information; or a parameter used to schedule the SIB 1; and
the part of parameters in the SIB 1 comprise at least one of the following: second cell inhibition state information, wherein the second cell inhibition state information is used to indicate a cell state; related information of an area to which a cell belongs; a related parameter of a cell selection criterion; or a parameter used to schedule another SIB.

18. The non-transitory readable storage medium according to claim 16, wherein the applying, by the terminal, a part of parameters in the target information comprises:
verifying or not verifying, by the terminal, security of at least one of the MIB or the SIB 1 based on the part of parameters in the target information.

19. The non-transitory readable storage medium according to claim 18, wherein the verifying or not verifying, by the terminal, security of at least one of the MIB or the SIB 1 based on the part of parameters in the target information comprises at least one of the following:
in a case that the target cell does not meet the cell selection criterion, not verifying, by the terminal, the security of at least one of the MIB or the SIB 1;
in a case that it is determined, based on at least one of the first cell inhibition state information or the second cell inhibition state information, that the target cell is in a barred state, performing, by the terminal, security verification on the MIB and the SIB 1;
in a case that it is determined, based on at least one of the first cell inhibition state information or the second cell inhibition state information, that the target cell is not in a barred state, and the target cell meets the cell selection criterion, performing, by the terminal, security verification on the MIB and the SIB 1; or
in a case that the target cell meets the cell selection criterion, performing, by the terminal, security verification on the MIB and the SIB 1.

20. A non-transitory readable storage medium, wherein the readable storage medium stores a program or an instruction; and when the program or the instruction is executed by a processor, the steps of the information processing method according to claim 12.
